(19) United States
(12) Patent Application Publication
(10) Pub. No.: US 2024/0391472 A1
(43) Pub. Date: Nov. 28, 2024

(54) CONTROL APPARATUS, CONTROL SYSTEM, CONTROL METHOD, AND PROGRAM

(71) Applicant: NIPPON TELEGRAPH AND TELEPHONE CORPORATION, Tokyo (JP)

(72) Inventors: Takuma TSUBAKI, Tokyo (JP); Ryota ISHIBASHI, Tokyo (JP); Takeshi KUWAHARA, Tokyo (JP)

(21) Appl. No.: 18/692,030

(22) PCT Filed: Sep. 22, 2021
(86) PCT No.: PCT/JP2021/034835

§ 371 Date: Mar. 14, 2024

(51) Int. Cl. B60W 50/00; G06V 20/58; H04N 23/667

(52) U.S. Cl. CPC B60W 50/00; B60W 2420/403; B60W 2420/408; G06V 20/58; H04N 23/667

(57) ABSTRACT

Provided is a control apparatus that controls a data acquisition cycle of a sensor of a mobile device in a control system including the mobile device and a mobile device control apparatus that controls the mobile device by analyzing data periodically acquired by the sensor, the control apparatus including: acquisition means for acquiring a speed of the mobile device; and determination means for determining the data acquisition cycle to be set for the sensor, based on the speed and a maximum data acquisition cycle of the sensor to satisfy an allowable reaction distance in the mobile device.

### TECHNICAL FIELD

The present invention relates to a technology for controlling a mobile device.

### BACKGROUND ART

Implementation of data analysis such as obstacle detection by utilizing videos from in-vehicle cameras or LIDAR sensing data, and implementation of automatic control of mobile devices such as cars or agricultural machines have been studied.

For example, Non Patent Literature 1 discloses automatic control by a computational resource on a mobile device side as automatic control by video analysis in an automatic driving vehicle. In this technology, video analysis with a fixed quality (full HD/30 FPS) is performed, and automatic control is performed. However, even when a vehicle is stopped (0 km/h), video with a fixed quality flows, and thus edge computational resources are continuously used.

Non Patent Literature 2 discloses automatic control by network cooperation (edge/cloud cooperation). In this technology, control is performed by changing a video bit rate at a fixed FPS (10 or 30 FPS). However, since the detection accuracy of an object or the like decreases, functionality may not be maintained.

### CITATION LIST

### Non Patent Literature

Non Patent Literature 1: Research and development and demonstration project for Social Implementation of Advanced Autonomous Driving Systems in 2018: Research and Development Project for Establishing Safety Evaluation Technology for Autonomous Driving Systems https://www.meti.go.jp/meti_lib/report/H30FY/000351.pdf
Non Patent Literature 2: Tobeta, Takamuku, Natori, Honda, Hiraiwa, and Mizuno, “Deep image restoration for object detection in compressed dashcam videos”, The 34th Annual Conference of the Japanese Society for Artificial Intelligence, 2020

### SUMMARY OF INVENTION

### Technical Problem

In the related art of automatic control of a mobile device, computational resources are mainly deployed on the mobile device side. In the future, by performing high-load processing such as data analysis on the edge/cloud side (hereinafter referred to as the edge), it is considered that further reductions in costs due to reductions in the computational resources on the mobile device side will be achieved while maintaining functionality.

In addition, in order to reduce the costs including that of the edge, it is required to control more mobile devices (sensors such as in-vehicle cameras) with less computational resources on the edge side.

The present invention has been made in view of the above points, and an object of the present invention is to provide a technology for accommodating more sensors for the same computational resource by efficiently using computational resources in automatic control of a mobile device.

### Solution to Problem

According to the disclosed technology, there is provided a control apparatus that controls a data acquisition cycle of a sensor of a mobile device in a control system including the mobile device and a mobile device control apparatus that controls the mobile device by analyzing data periodically acquired by the sensor, the control apparatus including:
acquisition means for acquiring a speed of the mobile device; and
determination means for determining the data acquisition cycle to be set for the sensor, based on the speed and a maximum data acquisition cycle of the sensor to satisfy an allowable reaction distance in the mobile device.

### Advantageous Effects of Invention

According to the disclosed technology, it is possible to accommodate more sensors for the same computational resource by efficiently utilizing computational resources in automatic control of a mobile device.

### BRIEF DESCRIPTION OF DRAWINGS

FIG. 1 is a diagram for describing an overview of an embodiment of the present invention.

FIG. 2 is a diagram for describing an overview of an embodiment of the present invention.

FIG. 3 is a diagram for describing an example of a model and a calculation formula in an embodiment of the present invention.

FIG. 4 is a diagram for describing t_{TAT}.

FIG. 5 is a diagram illustrating a system configuration example according to an embodiment of the present invention.

FIG. 6 is a flowchart for describing an operation example.

FIG. 7 is a diagram illustrating an example of in-vehicle camera information.

FIG. 8 is a diagram illustrating an example of application information.

FIG. 9 is a diagram illustrating a speed at each time.

FIG. 10 is a diagram illustrating FPS at each time.

FIG. 11 is a diagram illustrating an example of in-vehicle camera information.

FIG. 12 is a diagram illustrating a speed and an acceleration at each time.

FIG. 13 is a diagram illustrating FPS at each time.

FIG. 14 is a diagram illustrating a hardware configuration example of a device.

### DESCRIPTION OF EMBODIMENTS

An embodiment of the present invention (present embodiment) will be described below with reference to the drawings. The embodiment described below is merely an example, and embodiments to which the present invention is applied are not limited to the following embodiment.

### Overview of Embodiment

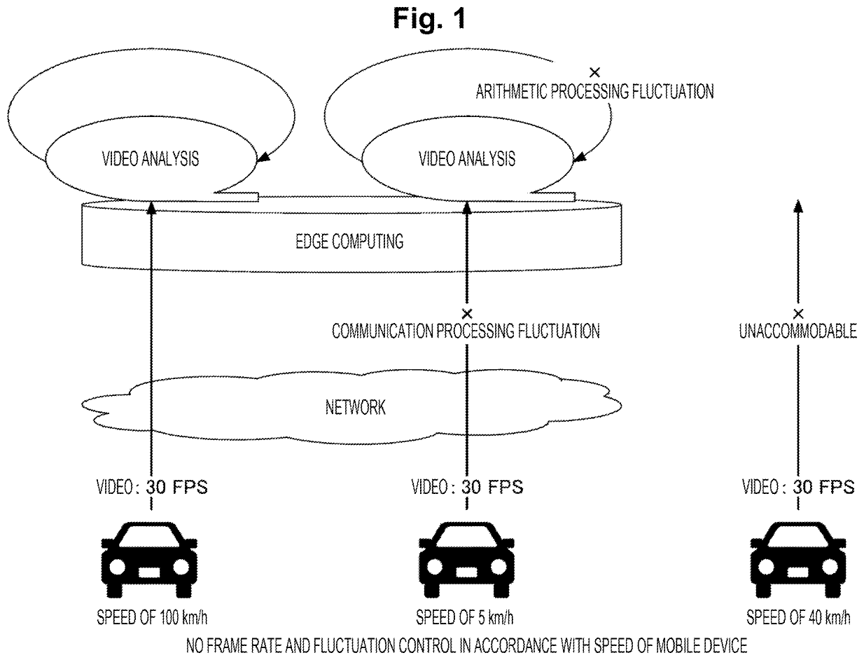

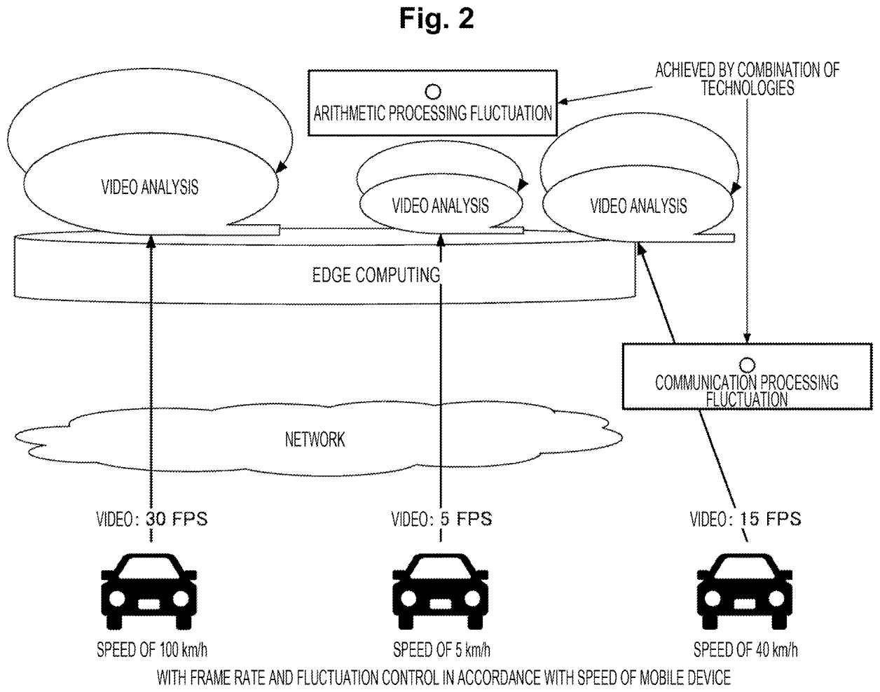

First, an overview of the present embodiment will be described with reference to FIGS. 1 and 2. In the present embodiment, an automobile is assumed as a mobile device, and automatic control of the mobile device is performed on the basis of sensor data or the like obtained from the mobile device.

In the automatic control, a local-side control unit or an edge-side control unit (collectively referred to as a control unit; the control unit may also be referred to as a control circuit), which will be described later, changes the content of data transmitted from sensors such as an in-vehicle camera in accordance with mobile device information such as speed/acceleration of the mobile device and environment information such as a traveling location.

An example in which the sensor is a camera will be described. In this case, the video quality of the camera is changed. For example, it is assumed that video quality=frame rate (FPS), and a computational resource capable of accommodating four 30 FPS cameras (a computational resource capable of performing 120 FPS processing) can be used as a video analysis resource. By controlling the FPS in accordance with the speed of the mobile device, for example, the FPS per camera can be set to 15 FPS. Accordingly, eight cameras can be accommodated with the same computational resource.

A more specific example will be described with reference to FIGS. 1 and 2. In the examples of FIGS. 1 and 2, it is assumed that there is a mobile device control apparatus on the edge side, and the mobile device control apparatus receives a video from a mobile device and performs video analysis.

FIG. 1 illustrates an example of a case where the frame rate is not controlled in accordance with the speed of each of mobile devices. Each of the mobile devices (automobiles) captures and outputs a 30 FPS video with a camera. On the other hand, since the accommodation capacity of the mobile device control apparatus on the edge side is 60 FPS for two cameras, only two of the three mobile devices illustrated in the drawing can be accommodated. In the example of FIG. 1, there is a mobile device that moves at a speed of 5 km/h, but the video from the mobile device remains at 30 FPS, and the frame rate is not controlled.

On the other hand, in the example illustrated in FIG. 2, three mobile devices can be accommodated by performing control to lower the FPS in a mobile device moving at a low speed. In the example of FIG. 2, arithmetic processing fluctuation and communication processing fluctuation are also controlled, and the processing time and the delay time are stabilized.

In the present embodiment, excessive allocation of computational resources ignoring variations in mobile devices and environments is prevented, and computational resource utilization efficiency is improved in the entire system including mobile devices and edges. Furthermore, it is possible to enhance the stability of the entire system by combining technologies for preventing arithmetic processing fluctuation and communication processing fluctuation.

With the control as described above, it is possible to increase the number of sensors (the number of cameras or the like) that can be accommodated with respect to computational resources on the edge side.

In the technology of the embodiment described below, as an example, an example will be described in which a video output from a sensor of a mobile device is analyzed on the edge side and control on the mobile device is performed. Note that the video is an example of periodically acquired data.

### (Model, Calculation Formula)

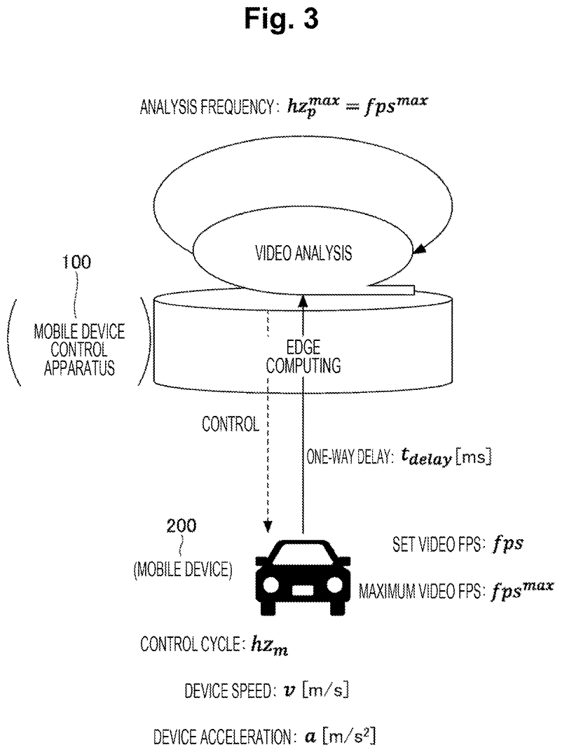

Next, examples of a model and a calculation formula used in the present embodiment will be described. FIG. 3 illustrates a basic configuration, variables used in calculation, and the like in the present embodiment.

As illustrated in FIG. 3, a mobile device 200 (an automobile) exists on the local side, and a mobile device control apparatus 100 exists on the edge side. The mobile device 200 and the mobile device control apparatus 100 can communicate with each other via a network.

In the present embodiment, the video quality is changed in consideration of a control cycle, a mobile device speed, and a mobile device acceleration which are mobile device information. Furthermore, it is possible to achieve a state in which there is no arithmetic processing/communication processing fluctuation by computational resource allocation and time sensitive network (TSN) control.

Note that the computational resource allocation itself is an existing technology, and for example, as a specific technology, CPU and memory allocation technology of Kubernetes (https://kubernetes.io/ja/docs/tasks/configure-pod-container/assign-cpu-resource/) can be used. In addition, the TSN control itself is also an existing technology (IEEE 802.1 (https://1.ieee802.org/tsn/)).

Since the computational resource allocation and the TSN control are exclusive (independent), either one of the computational resource allocation and the TSN control may be performed, or both may be performed in combination. Alternatively, neither the computational resource allocation nor the TSN control may be performed.

Hereinafter, a case where control for changing the FPS is performed using the FPS as an example of the video quality will be described. Note that this is an example. By using a data acquisition cycle other than the FPS, similar control can be performed on data other than video.

As illustrated in FIG. 3, meanings of variables used for calculation are as follows.
Control cycle of mobile device: hzₘ
Mobile device speed: v [m/s]
Mobile device acceleration: a [m/s²]
Set video FPS in mobile device: fps
Maximum video FPS in mobile device: fps^{max}
One-way delay between mobile device and mobile device control apparatus: t_{delay} [ms]
Analysis frequency in mobile device control apparatus: hzₚ^{max}=fps^{max}

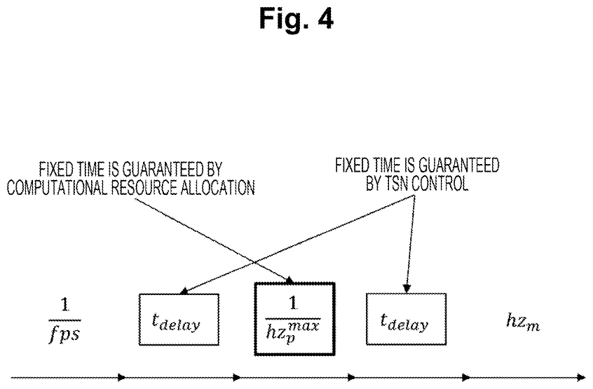

FIG. 4 is a diagram for describing t_{TAT}. t_{TAT} is a time from a certain video frame to the timing of control in the mobile device by analysis based on the video frame. In other words, THAT is a time from when an object that is not shown in the immediately preceding video frame is detected in the mobile device to when the object is fed back to the device control.

Here, it is assumed that both computational resource allocation and TSN control are performed. 1/fps in FIG. 4 is a time between frames. t_{delay} is a one-way delay, and a fixed time is guaranteed by TSN control. 1/(hzₚ^{max}) is a time required for video analysis. hzₘ is a time required for control in the mobile device. By adding these together, t_{TAT} can be calculated as follows.

$$[ Math . 1 ]$$

$${t}_{TAT} = \frac{1}{fps} + {t}_{delay} + \frac{1}{{fps}^{max}} + {t}_{delay} + {hz}_{m}$$

By using t_{TAT}, a reaction distance can be calculated as d_{f}=v×t_{TAT}. The reaction distance is, for example, a time from when a person appears in a video frame to when the video analysis is performed and the braking operation of the automobile is started.

Then, an allowable reaction distance (=difference in the reaction distance from the comparison target) dₜ is defined by the following Equations (1) to (4).

$$[ Math . 2 ]$$

$${d}_{t} = {d}_{f} - {d}_{fmax} \qquad ( 1 )$$

$$[ Math . 3 ]$$

$${d}_{t} = {vt}_{TAT} - {vt}_{{TAT}^{max}} \qquad ( 2 )$$

$$[ Math . 4 ]$$

$${d}_{t} = v ( \frac{1}{fps} + {t}_{delay} + \frac{1}{{fps}^{max}} + {t}_{delay} + {hz}_{m} ) - v ( \frac{1}{{fps}^{max}} + {t}_{delay} + \frac{1}{{fps}^{max}} + {t}_{delay} + {hz}_{m} ) \qquad ( 3 )$$

$$[ Math . 5 ]$$

$${d}_{t} = v ( \frac{1}{fps} - \frac{1}{{fps}^{max}} ) \qquad ( 4 )$$

As shown in Equation (1), the allowable reaction distance is calculated as a value obtained by subtracting the reaction distance based on the maximum video FPS from the reaction distance based on the set video FPS. The following Equation (5) is obtained from Equation (4).

$$[ Math . 6 ]$$

$$fps = \frac{1}{\frac{{d}_{t}}{v} + \frac{1}{{fps}^{max}}} \qquad ( 5 )$$

From Equation (5), it is possible to calculate the frame rate (fps) according to v by giving dₜ and fps^{max} in advance. In the calculation of Equation (5), when v=0, a settable minimum FPS is set, and the calculation result is rounded up to the nearest decimal point (because FPS is an integer value). Furthermore, as will be described later, a speed acquired from the mobile device in real time may be used as v, or a legal speed that is determined based on the position of the mobile device may be used.

### (System Configuration)

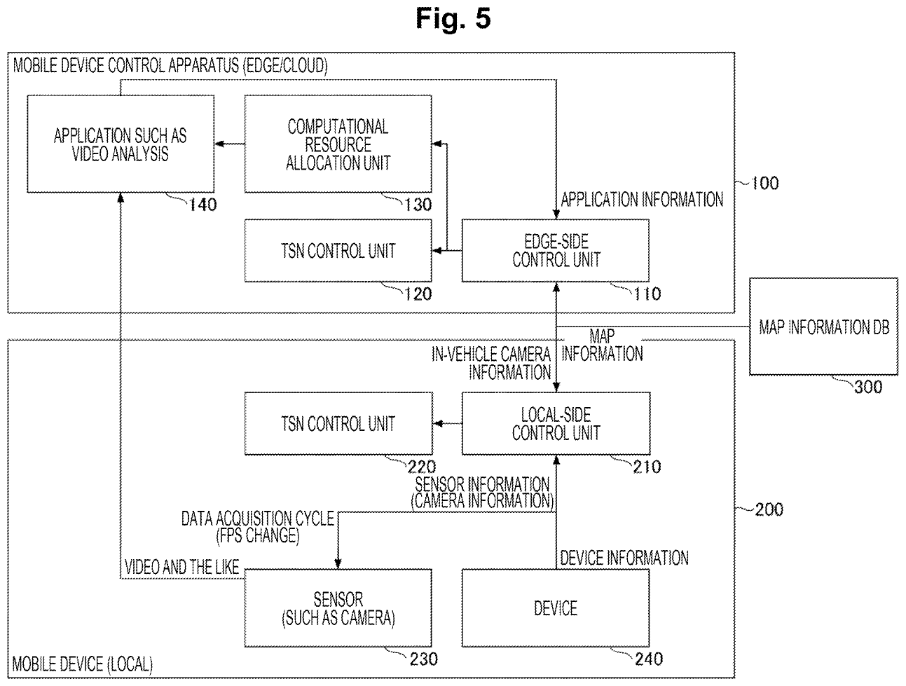

FIG. 5 illustrates a configuration example of a control system according to the present embodiment. As illustrated in FIG. 5, there are the mobile device control apparatus 100 provided on the edge side and the mobile device 200 on the local side.

The mobile device control apparatus 100 includes an edge-side control unit 110, a TSN control unit 120, a computational resource allocation unit 130, and an application 140 such as video analysis. Note that the edge-side control unit 110 may be referred to as a control apparatus. An apparatus including the edge-side control unit 110 may be referred to as a control apparatus.

The edge-side control unit 110 executes control according to the present proposal. The TSN control unit 120 performs the TSN control together with a TSN control unit 220 of the mobile device 200 so that the delay time between the mobile device control apparatus 100 and the mobile device 200 becomes a fixed time.

The computational resource allocation unit 130 executes computational resource allocation control for the application 140 so that the analysis speed (analysis time) becomes constant. The application 140 is, for example, an application including functions such as analyzing a video and instructing the mobile device 200 to stop when it is determined to be dangerous.

The mobile device 200 includes a local-side control unit 210, a TSN control unit 220, a sensor 230 such as a camera, and a device 240. Note that the local-side control unit 210 may be referred to as a control apparatus. An apparatus including the local-side control unit 210 may be referred to as a control apparatus.

The local-side control unit 210 executes control according to the present proposal. The TSN control unit 220 performs TSN control together with the TSN control unit 120 on the edge side so that the delay time becomes a fixed time. The device 240 is a main body of the mobile device (for example, the automobile), and includes a speedometer, an accelerometer, and the like. The sensor 230 is a device that periodically acquires sensor data.

As illustrated in FIG. 5, a map information DB 300 may be provided, and an operation of acquiring map information from the map information DB 300 may be performed.

Note that the local-side control unit 210 (or the edge-side control unit 110) includes: acquisition means for acquiring a speed of the mobile device; and determination means for determining a data acquisition cycle to be set for the sensor, based on the speed and a maximum data acquisition cycle of the sensor to satisfy an allowable reaction distance in the mobile device. Both the acquisition means and the determination means may be replaced with “circuits”. In addition, “to satisfy an allowable reaction distance” may mean that the reaction distance, which is additionally generated in a case where analysis is performed at the data acquisition cycle set for the sensor as compared with a case where analysis is performed at the maximum data acquisition cycle, is a maximum value equal to or less than a predetermined allowable value, for example.

### (Operation Example of System)

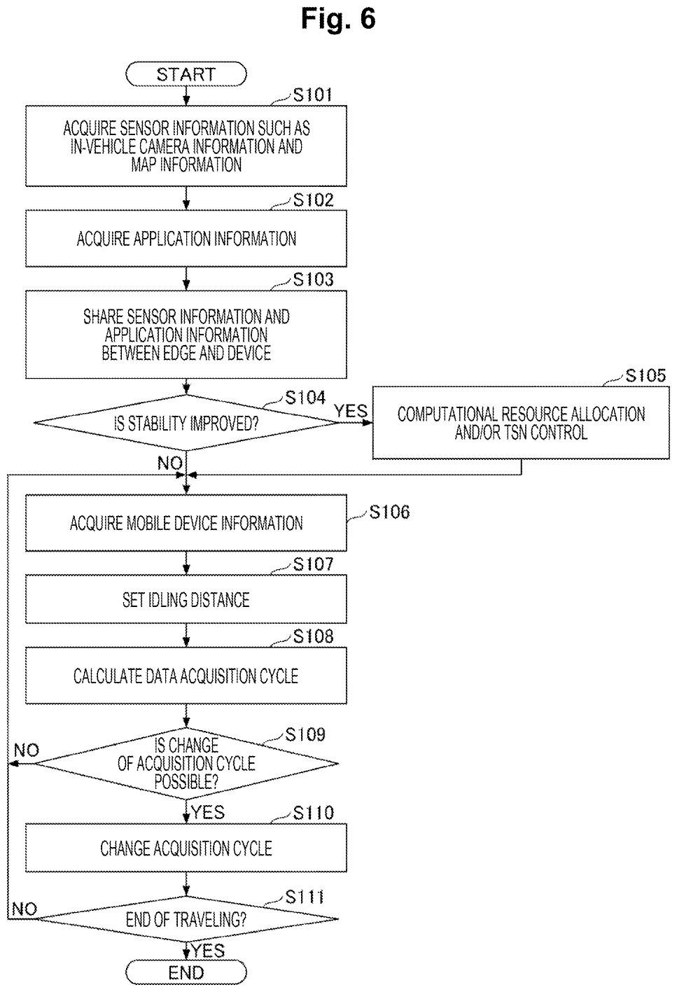

Next, an operation example of the system having the configuration illustrated in FIG. 5 will be described with reference to FIG. 6. In S101, the local-side control unit 210 acquires sensor information such as in-vehicle camera information from the sensor 230. The in-vehicle camera information is, for example, a maximum FPS, a settable FPS, or the like. Here, the map information may be acquired from the map information DB 300.

In S102, the edge-side control unit 110 acquires the application information from the application 140. The application information is, for example, an analysis frequency (for example, time required for analysis per video frame). In S103, the sensor information and the application information are shared between the edge and the device by communication between the edge-side control unit 110 and the local-side control unit 210. That is, the information acquired by the edge-side control unit 110 is transmitted to the local-side control unit 210, and the information acquired by the local-side control unit 210 is transmitted to the edge-side control unit 110.

In a case where the stability is improved (Yes in S104), the computational resource allocation unit 130 executes the computational resource allocation to the application 140 in S105. In addition, the TSN control unit 120 and the TSN control unit 220 execute TSN control.

Note that only one of the computational resource allocation and the TSN control may be executed. In addition, in a case where the stability is not improved, these steps are not performed. Note that the case where the stability is not improved may be, for example, a case where the delay or the analysis time is stable (close to a fixed value) without improving the stability.

In S106, the local-side control unit 210 acquires mobile device information from the device 240. The mobile device information is, for example, a speed, an acceleration, a control cycle, and the like. Note that, here, the subsequent processing is performed by the local-side control unit 210, but this is an example. The edge-side control unit 110 may execute the subsequent processing by transmitting the mobile device information to the edge side.

In S107, an allowable reaction distance corresponding to dₜ described above is acquired. Here, an allowable reaction distance, which is generated when the data acquisition cycle is reduced as compared to when data analysis is performed at the maximum data acquisition cycle of the sensor, is set in advance in a storage device such as a memory, and the allowable reaction distance is acquired. Note that the allowable reaction distance may include the control cycle of the device.

In S108, the local-side control unit 210 calculates a data acquisition cycle. In a case where the data is video, the FPS corresponding to the data acquisition cycle is calculated by calculating Equation (5) described above.

Basically, the local-side control unit 210 compares the acquisition cycle calculated in S108 with the currently set acquisition cycle, and changes the acquisition cycle if these are different. However, in a case where an in-vehicle camera is assumed as the sensor, since the change can be made only in units of FPS, in S109, it is determined whether or not the change to the acquisition cycle calculated in S108 is possible on the basis of a settable cycle (FPS). If possible, the process proceeds to S110. Otherwise, the process returns to S106.

In S110, the local-side control unit 210 sets the acquisition cycle calculated in S108 for the sensor 230. While the traveling is continued (No in S111), the processing of S106 to S111 is repeated, and the processing ends when the traveling ends.

Hereinafter, Examples 1 to 3 will be described as more specific examples of control. Examples 1 to 3 are examples of a case where the sensor is an in-vehicle camera and the application is a video analysis application. In the description of the examples, the functional unit names illustrated in FIG. 5 and the step numbers illustrated in FIG. 6 are appropriately used.

### Example 1

First, Example 1 will be described. In Example 1, FPS control using environment information and a device speed (legal speed) will be described. Example 1 is an example in which the control frequency is low. In addition, no processing is performed to improve stability.

### <S101 to S103>

The local-side control unit 210 acquires in-vehicle camera information from the sensor 230 (in-vehicle camera), and the edge-side control unit 110 acquires application information from the application 140 (video analysis application). Furthermore, here, the local-side control unit 210 (or the edge-side control unit 110) also acquires map information.

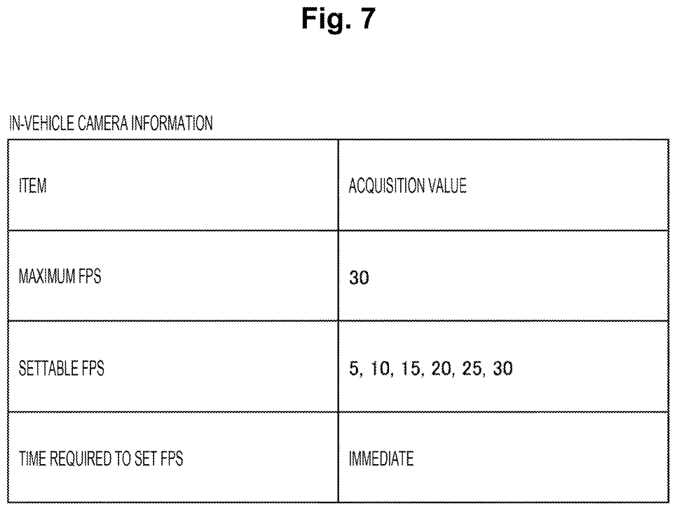

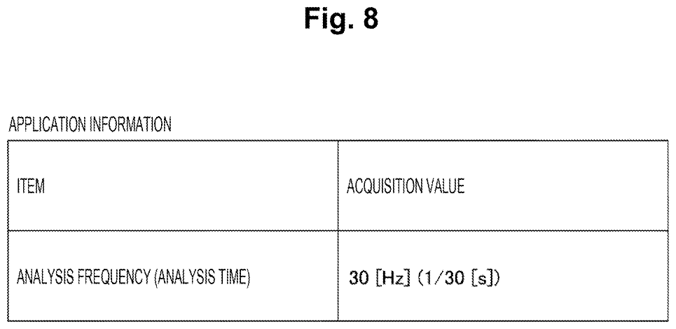

The sensor information, the application information, and the map information are shared between the edge and the device by communication between the edge-side control unit 110 and the local-side control unit 210. FIG. 7 illustrates an example of the in-vehicle camera information, and FIG. 8 illustrates an example of the application information.

### <S106>

In S106, the local-side control unit 210 acquires mobile device information from the device 240.

In Example 1, the local-side control unit 210 checks the presence or absence of a change in the legal speed at the place where the mobile device (automobile) is traveling from position information that is the map information and the sensor data, and acquires the mobile device information in a case where there is the change. At the first time, mobile device information is always acquired. Here, as a result of acquisition, it is assumed that legal speed=60 [km/h] and control cycle=10 [Hz].

In Example 1, as compared with the case where the control is performed with the maximum FPS of the camera, the allowable reaction distance is set up to 1.0 [m]. That is, hereinafter, the FPS can be lowered as long as the difference in distance generated until the camera video is analyzed at the edge or the like and fed back to the mobile device is within 1.0 [m].

### <S107 to S110>

The local-side control unit 210 calculates the FPS by substituting dₜ=1.0 [m], v=16.7 [m/s], (=60 [km/h]), and fps^{max}=30 into Equation (5).

$$fps = 1 / ( ( {d}_{t} / v ) + ( 1 / {fps}^{max} ) ) \approx 11$$

As illustrated in FIG. 7, since the settable FPS for the camera of the mobile device 200 is 15 [FPS] (10 [FPS] does not satisfy dₜ=1.0 [m]), the setting FPS of the camera is set from 30 to 15. Here, the first FPS is set to 30. By setting the FPS to 15, analysis can be performed with less computational resources than video analysis with the maximum FPS of 30 [FPS].

### <Subsequent S106 to S110>

Thereafter, it is assumed that the legal speed at the place where the mobile device 200 travels changes from 60 [km/h] to 30 [km/h].

When determining that there is a change in legal speed (from 60 [km/h] to 30 [km/h]) from the position information that is the map information and the sensor data, the local-side control unit 210 acquires mobile device information. As a result of the acquisition, it is assumed that legal speed=30 [km/h] and control cycle=10 [Hz]. Here too, the allowable reaction distance is 1.0 [m] set for the first time.

The local-side control unit 210 calculates the FPS by substituting dₜ=1.0 [m], v=8.3 [m/s], (=30 [km/h]), and fps^{max}=30 into Equation (5).

$$fps = 1 / ( ( {d}_{t} / v ) + ( 1 / {fps}^{max} ) ) \approx 7$$

From FIG. 7, since the settable FPS is 10 [FPS] (5 [FPS] does not satisfy dₜ=1.0 [m]), the setting FPS of the camera is changed from 15 to 10. Accordingly, analysis can be performed with less computational resources than video analysis with 15 [FPS].

### Example 2

Next, Example 2 will be described. In Example 2, FPS control using a real-time device speed will be described. Here, processing for improving stability is executed. In addition, Example 2 is an example in which the control frequency is high.

### <S101 to S103>

The local-side control unit 210 acquires in-vehicle camera information from the sensor 230 (in-vehicle camera), and the edge-side control unit 110 acquires application information from the application 140 (video analysis application).

The sensor information and the application information are shared between the edge and the device by communication between the edge-side control unit 110 and the local-side control unit 210. The in-vehicle camera information and the application information are the same as those in Example 1, and are as illustrated in FIGS. 7 and 8.

### <S105>

In Example 2, the analysis processing and the NW delay are fixed by the computational resource allocation control and the TSN control. Details are as follows.

In S105, the computational resource allocation unit 130 performs computational resource allocation processing. Accordingly, computational resources such as a CPU and a memory can be exclusively allocated, and a processing time required for an application such as video analysis to perform processing such as detection of a dangerous object in a video and feedback of a detection result to the device can be kept within an operation cycle (for example, every 100 [ms] or the like) required for automatic control of the device.

By combining the present functions, it is not necessary to consider the fluctuation in the processing time, and thus more camera videos can be processed. Note that, in the case of Example 1 in which the present functions are not combined, it may be necessary to process the camera video in a state where there are ample computational resources in consideration of the fluctuation in the processing time.

In addition, the TSN control unit 120 and the TSN control unit 220 control a mechanism of fluctuation guarantee of the data transfer time such as the TSN. Accordingly, the communication processing of transfer of the transmission data and the arithmetic processing result to the device can be kept within the operation cycle required for automatic control of the device. By combining the present functions, it is possible to prevent disturbance of the operation cycle due to communication fluctuation. Note that, in the case of Example 1 in which the present functions are not combined, disturbance of the operation cycle may occur due to communication fluctuation.

### <S106 to S111>

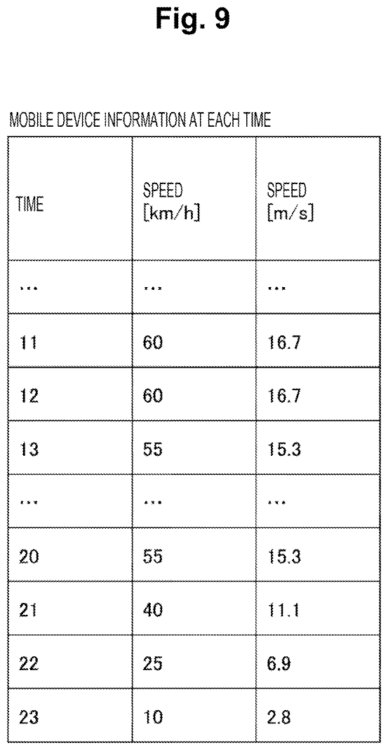

For example, the local-side control unit 210 acquires the speed of the mobile device 200 at the same frequency as the control cycle. FIG. 9 illustrates the speed acquired by repeatedly executing the loop (S106 to S111) from the acquisition of mobile device information to the determination of the end of traveling. The allowable reaction distance is 1.0 [m] as in Example 1.

The local-side control unit 210 calculates the FPS using Equation (5) in each loop, and determines whether to change the FPS.

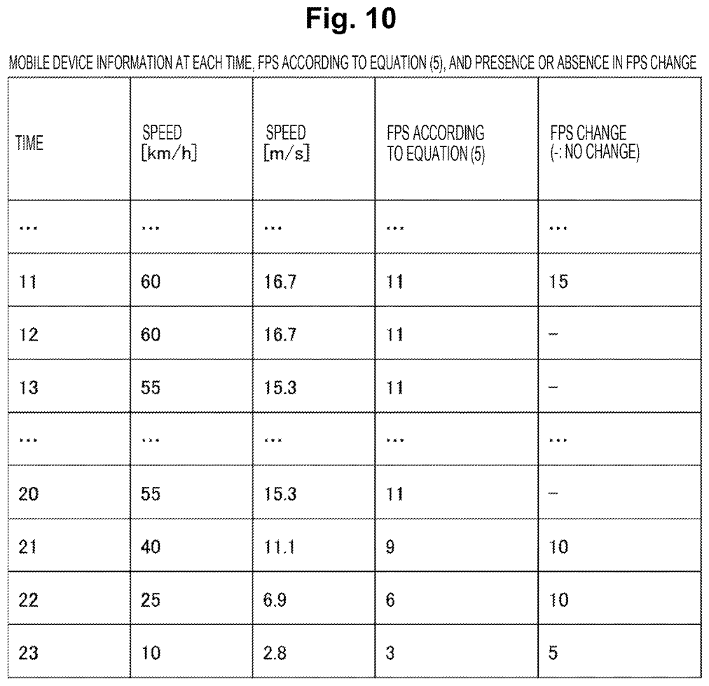

FIG. 10 illustrates the FPS calculated by Equation (5) for the speed at each time and the FPS set for the camera. In the example illustrated in FIG. 10, the FPS is changed to 15 at time 11. Although the speed decelerates at time 13, since the value of the FPS according to Equation (5) does not change, the FPS is not changed.

Next, the speed further decelerates at time 21, and the value of the FPS according to Equation (5) changes. Thus, the FPS is changed. On the other hand, the speed further decelerates at time 22, and the value of the FPS according to Equation (5) changes. However, since the settable FPS of the camera is 5 or 10, the FPS cannot be changed (is not changed). Finally, as a result of further deceleration of the speed at time 23, the FPS according to Equation (5) further decreases, and the FPS is changed.

### Example 3

Next, Example 3 will be described. In Example 3, FPS control using a real-time device speed and acceleration will be described. Here, no processing for improving stability is executed. Example 3 is an example in which the control frequency is high and time is required to set the camera.

### <S101 to S103>

The local-side control unit 210 acquires in-vehicle camera information from the sensor 230 (in-vehicle camera), and the edge-side control unit 110 acquires application information from the application 140 (video analysis application).

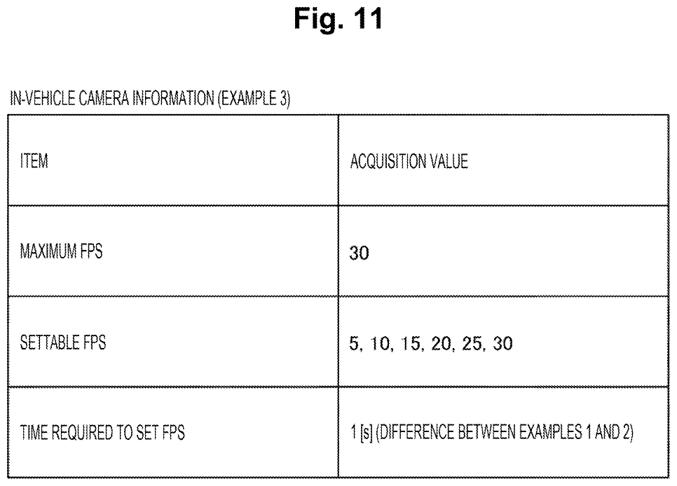

The sensor information and the application information are shared between the edge and the device by communication between the edge-side control unit 110 and the local-side control unit 210. FIG. 11 illustrates in-vehicle camera information in Example 3. The application information is the same as that in Example 1, and is as illustrated in FIG. 8.

### <S106 to S111>

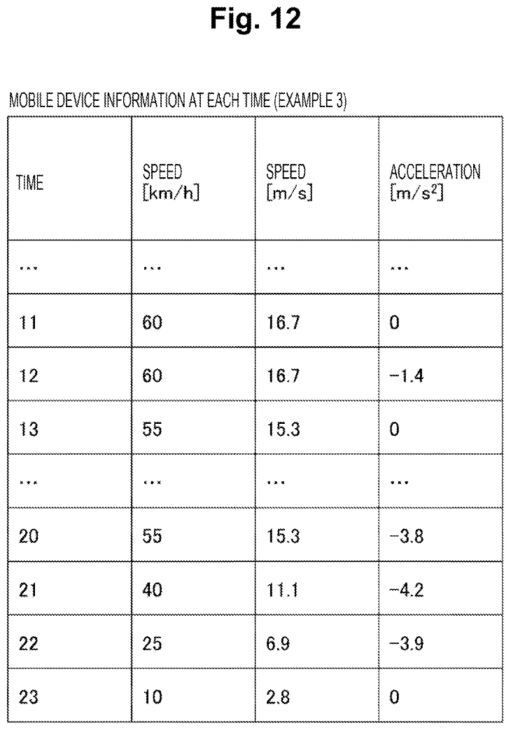

For example, the local-side control unit 210 acquires the speed and the acceleration of the mobile device 200 at the same frequency (in Example 3, 1 [Hz] and 1 [s] intervals) as the control cycle. FIG. 12 illustrates the speed and the acceleration acquired by repeatedly executing the loop (S106 to S111) from the acquisition of mobile device information to the determination of the end of traveling. The allowable reaction distance is 1.0 [m] as in Example 1.

In Example 3, the local-side control unit 210 calculates the FPS using the following Equation (5′) using the acceleration a and the time t [s] required to set the FPS in addition to the speed, and determines whether to change the FPS.

$$fps = 1 / ( ( {d}_{t} / ( v + at ) ) + ( 1 / {fps}^{max} ) ) \qquad Equation ( {5}^{′} )$$

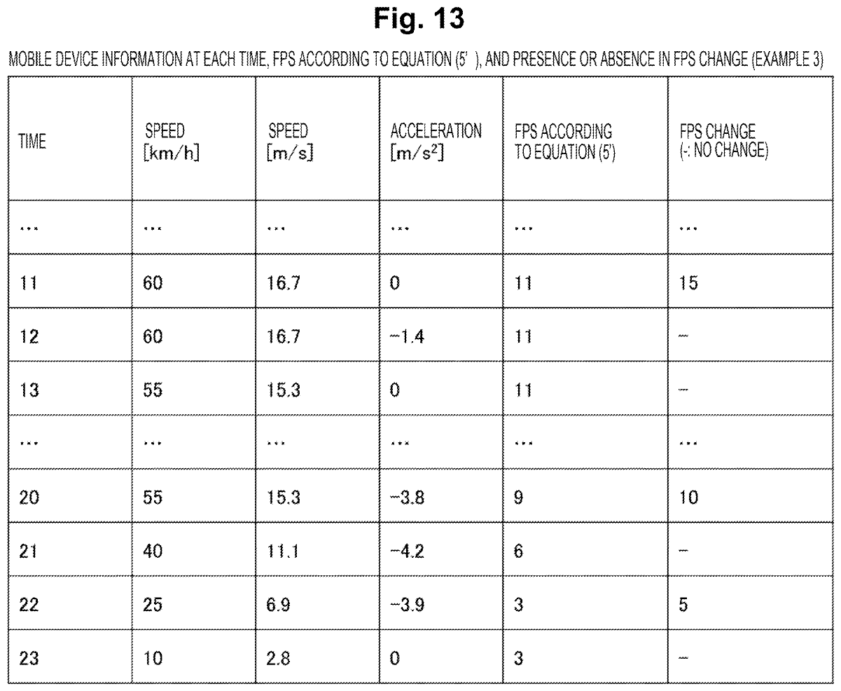

FIG. 13 illustrates the FPS calculated by Equation (5′) for the speed and the acceleration at each time and the FPS set for the camera. In the example illustrated in FIG. 13, the FPS is changed to 15 at time 11. Although the speed decelerates at time 13, since the value of the FPS according to Equation (5′) does not change, the FPS is not changed.

Next, the negative acceleration increases at time 20, and the value of the FPS according to Equation (5′) changes, so that the FPS is changed to 10. At time 22, the speed decelerates, and the value of the FPS according to Equation (5′) changes. Thus, the FPS is changed. Note that, in a case where it takes time to set the FPS of the camera, the future speed may be predicted, and the FPS corresponding thereto may be set in advance.

### Hardware Configuration Example

All of the mobile device control apparatus 100, the edge-side control unit 110, the local-side control unit 210, and the “local-side control unit 210+TSN control unit 220” described in the present embodiment (these are collectively referred to as an “apparatus”) can be implemented, for example, by causing a computer to execute a program. This computer may be a physical computer, or may be a virtual machine on a cloud.

Specifically, the apparatus can be implemented by executing a program corresponding to the processing to be performed in the apparatus, using hardware resources such as a CPU and a memory built into the computer. The above program can be stored and distributed by being recorded in a computer-readable recording medium (portable memory or the like). Furthermore, the above program can also be provided through a network such as the Internet or an electronic mail.

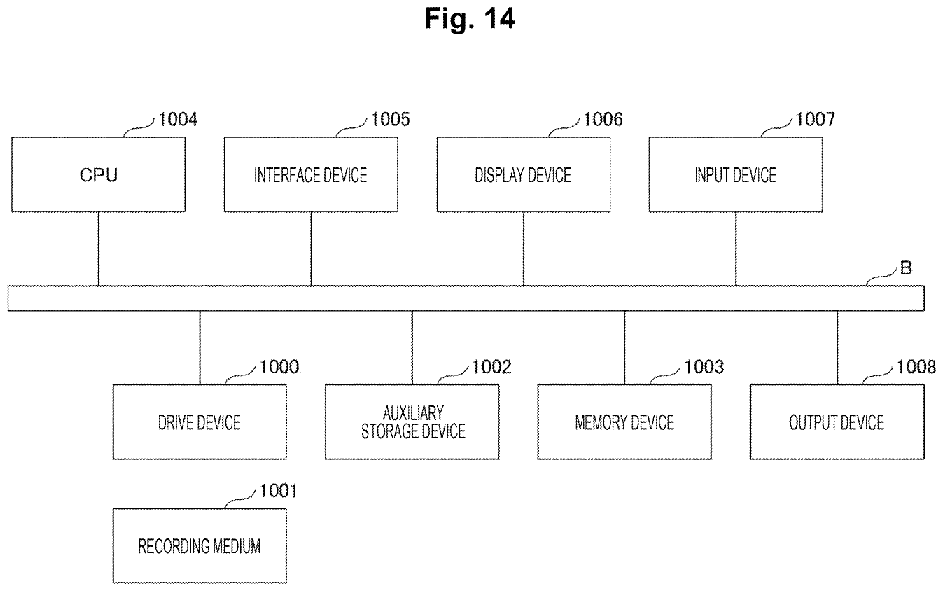

FIG. 14 is a diagram illustrating a hardware configuration example of the computer. The computer in FIG. 14 includes a drive device 1000, an auxiliary storage device 1002, a memory device 1003, a CPU 1004, an interface device 1005, a display device 1006, an input device 1007, an output device 1008, and the like, which are connected to each other by a bus BS.

The program for implementing the processing in the computer is provided by, for example, a recording medium 1001 such as a CD-ROM or a memory card. When the recording medium 1001 that stores the program is set in the drive device 1000, the program is installed from the recording medium 1001 to the auxiliary storage device 1002 via the drive device 1000. However, the program is not necessarily installed from the recording medium 1001, and may be downloaded from another computer via a network. The auxiliary storage device 1002 stores the installed program and also stores necessary files, data, and the like.

In a case where an instruction to start the program is made, the memory device 1003 reads the program from the auxiliary storage device 1002, and stores the program therein. The CPU 1004 implements a function related to the device in accordance with a program stored in the memory device 1003. The interface device 1005 is used as an interface for connection to the network, various measurement devices, an exercise intervention device, and the like. The display device 1006 displays a graphical user interface (GUI) or the like by the program. The input device 1007 includes a keyboard and a mouse, buttons, a touch panel, or the like, and is used to input various operation instructions. The output device 1008 outputs a computation result.

### Effects of Embodiment

With the technology according to the present embodiment, it is possible to accommodate more sensors for the same computational resource by efficiently utilizing computational resources in automatic control of a mobile device.

### Supplementary Notes

This specification discloses at least a control apparatus, a control system, a control method, and a program according to the following items.

### (Item 1)

A control apparatus that controls a data acquisition cycle of a sensor of a mobile device in a control system including the mobile device and a mobile device control apparatus that controls the mobile device by performing analysis of data periodically acquired by the sensor, the control apparatus including:
acquisition means for acquiring a speed of the mobile device; and
determination means for determining the data acquisition cycle to be set for the sensor, based on the speed and a maximum data acquisition cycle of the sensor to satisfy an allowable reaction distance in the mobile device.

### (Item 2)

The control apparatus according to Item 1, in which the acquisition means acquires, as the speed, a legal speed that is determined based on map information, or acquires the speed from the mobile device.

### (Item 3)

The control apparatus according to Item 1 or 2, in which the allowable reaction distance is an allowable reaction distance that is additionally generated in a case where the analysis is performed at the data acquisition cycle set for the sensor as compared with a case where the analysis is performed at the maximum data acquisition cycle.

### (Item 4)

The control apparatus according to any one of Items 1 to 3, in which the determination means determines the data acquisition cycle to be set for the sensor by further using an acceleration of the mobile device and a time required to set the data acquisition cycle to the sensor.

### (Item 5)

A control system including a mobile device and a mobile device control apparatus that controls the mobile device by analyzing data periodically acquired by a sensor of the mobile device, the control system including:
acquisition means for acquiring a speed of the mobile device; and
determination means for determining a data acquisition cycle to be set for the sensor, based on the speed and a maximum data acquisition cycle of the sensor to satisfy an allowable reaction distance in the mobile device.

### (Item 6)

The control system according to Item 5, further including:
network control means for stabilizing communication between the mobile device and the mobile device control apparatus, computational resource control means for stabilizing analysis processing in the mobile device control apparatus, or both the network control means and the computational resource control means.

### (Item 7)

A control method executed by a control apparatus that controls a data acquisition cycle of a sensor of a mobile device in a control system including the mobile device and a mobile device control apparatus that controls the mobile device by analyzing data periodically acquired by the sensor, the control method including:
an acquisition step of acquiring a speed of the mobile device; and
a determination step of determining the data acquisition cycle to be set for the sensor, based on the speed and a maximum data acquisition cycle of the sensor to satisfy an allowable reaction distance in the mobile device.

### (Item 8)

A program for causing a computer to function as the control apparatus according to any one of Items 1 to 4.

While the present embodiment has been described above, the present invention is not limited to such a specific embodiment, and various modifications and changes can be made within the scope of the gist of the present invention described in the claims.

### REFERENCE SIGNS LIST

100 Mobile device control apparatus
110 Edge-side control unit
120 TSN control unit
130 Computational resource allocation unit
140 Application
200 Mobile device
210 Local-side control unit
220 TSN control unit
230 Sensor
240 Device
300 Map information DB
1000 Drive device
1001 Recording medium
1002 Auxiliary storage device
1003 Memory device
1004 CPU
1005 Interface device
1006 Display device
1007 Input device
1008 Output device

1. A control apparatus that controls a data acquisition cycle of a sensor of a mobile device in a control system including the mobile device and a mobile device control apparatus that controls the mobile device by performing analysis of data periodically acquired by the sensor, the control apparatus comprising:
a processor; and
a memory storing program instructions that cause the processor to:
acquire a speed of the mobile device; and
determine the data acquisition cycle to be set for the sensor, based on the speed and a maximum data acquisition cycle of the sensor to satisfy an allowable reaction distance in the mobile device.

2. The control apparatus according to claim 1, wherein the program instructions cause the processor to acquire, as the speed, a legal speed that is determined based on map information, or acquire the speed from the mobile device.

3. The control apparatus according to claim 1, wherein the allowable reaction distance is an allowable reaction distance that is additionally generated in a case where the analysis is performed at the data acquisition cycle set for the sensor as compared with a case where the analysis is performed at the maximum data acquisition cycle.

4. The control apparatus according to claim 1, wherein the program instructions cause the processor to determine the data acquisition cycle to be set for the sensor by further using an acceleration of the mobile device and a time required to set the data acquisition cycle to the sensor.

5. A control system including a mobile device and a mobile device control apparatus that controls the mobile device by analyzing data periodically acquired by a sensor of the mobile device, the control system comprising:
a processor; and
a memory storing program instructions that cause the processor to:
acquire a speed of the mobile device; and
determine a data acquisition cycle to be set for the sensor, based on the speed and a maximum data acquisition cycle of the sensor to satisfy an allowable reaction distance in the mobile device.

6. The control system according to claim 5, wherein the program instructions cause the processor to stabilize communication between the mobile device and the mobile device control apparatus, stabilize analysis processing in the mobile device control apparatus, or stabilize both the communication and the analysis processing.

7. A control method executed by a control apparatus that controls a data acquisition cycle of a sensor of a mobile device in a control system including the mobile device and a mobile device control apparatus that controls the mobile device by analyzing data periodically acquired by the sensor, the control method comprising:
acquiring a speed of the mobile device; and
determining the data acquisition cycle to be set for the sensor, based on the speed and a maximum data acquisition cycle of the sensor to satisfy an allowable reaction distance in the mobile device.

8. A non-transitory computer-readable recording medium storing a program for causing a computer to perform the control method of claim 7.
